(19) United States
(12) Patent Application Publication
(10) Pub. No.: US 2006/0074173 A1
(43) Pub. Date: Apr. 6, 2006

(54) High purity titanium oxide and production process thereof

(76) Inventors: Hisao Kogoi, Toyama-shi (JP); Jun Tanaka, Toyama-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/507,776

(22) PCT Filed: Mar. 20, 2003
(86) PCT No.: PCT/JP03/03470

§ 371 Date: Sep. 6, 2005

Related U.S. Application Data
(60) Provisional application No. 60/367,272, filed on Mar. 26, 2002.

(30) Foreign Application Priority Data
Mar. 20, 2002 (JP) 2002-78850

(51) Int. Cl. C01G 23/047; C08K 3/22

(52) U.S. Cl. 524/497; 502/350; 423/610

(57) ABSTRACT

A titanium dioxide characterized by having an average particle size of 5 to 200 μm as measured through laser particle size analysis; having a purity of at least 99.5 mass % as reduced to TiO₂; and having an Fe content of 20 mass ppm or less, an Ni content of 20 mass ppm or less, a Cr content of 20 mass ppm or less, an Al content of 20 mass ppm or less, a Zr content of 20 mass ppm or less, an Si content of 40 mass ppm or less, a Cl content of 0.05 mass % or less, and an S content of 50 mass ppm or less. The titanium dioxide is produced by a process comprising bringing titanium dioxide serving as a raw material into a high-temperature flame formed by use of a combustible gas and a combustion-supporting gas, to thereby yield spherical titanium dioxide, characterized in that said raw material titanium dioxide has been produced through a vapor-phase process in which titanium tetrachloride is oxidized with an oxidative gas at high temperature.

### CROSS REFERENCE TO RELATED APPLICATION

This application is an application filed under 35 U.S.C. §111(a) claiming benefit pursuant to 35 U.S.C. §119(e)(1) of the filing date of the Provisional Application No. 60/367,272 filed on Mar. 26, 2002, pursuant to 35 U.S.C. §111(b).

### FIELD OF THE INVENTION

The present invention relates to spherical titanium dioxide which is produced through bringing titanium dioxide serving as a raw material into a high-temperature flame. The spherical titanium dioxide product has an average particle size of 5 to 200 μm as measured through laser particle size analysis, and contains less amounts of impurities such as Fe, Ni, Cr, Si, Al, Zr, S, and Cl. The invention also relates to a process for producing the titanium dioxide.

### BACKGROUND ART

Titanium dioxide powder is widely employed in white pigments and cosmetic compositions, and is employed as, for example, a raw material for barium titanate, which is a dielectric material, or as a photocatalyst. Titanium dioxide powder is employed in white pigments and cosmetic compositions, by virtue of its excellent concealment characteristics and ultraviolet shielding ability. In order to sufficiently obtain such characteristics of titanium dioxide powder upon use thereof, the powder must be formed into dispersions containing very small amounts of aggregated particles, for the following reasons. When aggregated particles are present in titanium dioxide powder, the powder provides inferior tactile sensation and smoothness. When such titanium dioxide powder is applied to the skin, the powder fails to be spread uniformly over the skin, and therefore the powder exhibits poor ultraviolet shielding and non-uniform concealment characteristics.

When titanium dioxide powder is employed as a raw material for barium titanate, which is a dielectric material, or for other ceramic materials, in general, a slurry containing titanium dioxide powder and other components is prepared, and the slurry is subjected to mixing or milling, and then shaping, followed by sintering. One reason for employing such a process in producing a sintered product is to prevent segregation of raw material components in the sintered product. Segregation of the raw material components causes non-uniform structural growth during the course of sintering, which causes lowering of strength or functional problems of the sintered product. Pores (closed pores or open pores) contained in titanium dioxide particles cause non-uniform structural growth, leading to lowering of the strength of the sintered product and impairment of functions thereof. In many cases, aggregated particles cause segregation of raw material components. The amount of aggregated particles can be reduced through a mixing/milling process. However, in order to reduce the amount of aggregated particles to a level such that titanium dioxide powder can be employed in practice, a very large amount of energy is required for the mixing/milling process. Therefore, it is desired that titanium dioxide powder serving as a raw material exhibits high dispersibility; i.e., the powder is readily mixed with other components.

The particle size of titanium dioxide powder is a critical factor, from the viewpoint of prevention of segregation of a single component. When titanium dioxide powder is employed for producing a ceramic material, in some cases, a plurality of powdery components of different particle sizes are mixed, and the resultant mixture is subjected to shaping and sintering. When titanium dioxide powder can be readily dispersed in a plurality of powdery components of different particle sizes, a process for making the particle size of the powder uniform, which requires a large amount of energy, can be omitted. Titanium dioxide powder having a particle size of 5 to 200 μm and exhibiting excellent dispersibility (the sintered product thereof must have uniform composition) is very useful as, for example, a ceramic raw material for producing an electronic material. In some cases, such titanium dioxide powder is required to have high purity, as well as uniform composition. This is because titanium dioxide powder having high purity is envisaged to exhibit further improved functions.

Highly dispersible titanium dioxide powder of high purity containing no pores is a favorable raw material, not only for producing ceramic products but also rutile single crystals employed as a polarizer material of a photoisolator. Examples of methods for producing rutile single crystals include the Bernoulli method in which titanium dioxide powder is brought into an oxygen-hydrogen flame, to thereby grow single crystals; and the floating zone method in which a sample is heated and melted by means of energy obtained through convergence of light from a light source, to thereby grow single crystals. In the case of the Bernoulli method, the purity and fluidity of titanium dioxide powder are critical factors, whereas in the case of the floating zone method, the purity and moldability of titanium dioxide powder are critical factors. In general, the fluidity of titanium dioxide powder is regulated through granulation. However, granulation is not required for titanium dioxide powder having a particle size of 5 to 200 μm. Titanium dioxide powder which can be uniformly dispersed in powders of different particle sizes exhibits excellent moldability. Since rutile single crystals are desired to have no color, raw material titanium dioxide powder is required to have high purity. In addition, desirably, the powder does not contain pores in particles thereof, which would cause scattering of light that passes through the particles.

The photocatalytic mechanism of titanium dioxide will next be described. Titanium dioxide absorbs UV rays having a wavelength of about 400 nm or less, to thereby excite electrons thereof. When the resultant electrons and holes reach the surfaces of titanium dioxide particles, the electrons and holes react with oxygen or water, thereby generating various radicals. The resultant radicals exert an oxidizing effect to thereby oxidize and decompose substances adsorbed on the surfaces of the particles.

In order to utilize the photocatalytic activity of titanium dioxide, titanium dioxide must be supported on the surface of a structure such that the titanium dioxide readily adsorbs substances. In a general process for coating a structure with titanium dioxide, a slurry containing titanium dioxide is applied onto the structure, and then the slurry is dried. If aggregated particles are present in the slurry, when the slurry is dried or solidified, the aggregated particles are supported on the structure. As a result, the composition of the coating film becomes non-uniform, and transparency and smoothness of the film are impaired, possibly lowering the value of the structure as a product. In order to cause the titanium dioxide to exhibit its photocatalytic activity, the titanium dioxide must be exposed on the surface of the coating film. When an organic binder is employed, the thickness of the film is generally some μm to some tens of μm. Therefore, when photocatalytic titanium dioxide particles having an average size of about 5 to about 200 μm are employed, there is a high likelihood that the particles are partially exposed on the surface of the coating film, and thus the particles exhibit sufficient photocatalytic activity. Titanium dioxide whose photocatalytic activity is to be utilized is desired to have high purity, since impurities contained in titanium dioxide may lower photocatalytic activity thereof. For example, Fe and Cl are undesirable impurities, since they trap generated radicals.

As described above, there has been demand for titanium dioxide powder which can be widely employed, which exhibits high dispersibility, which has high purity, and which contains no pores. Since the suitable particle size of titanium dioxide powder varies according to its intended use, demand has also arisen for a technique for producing titanium dioxide powder of arbitrary particle size.

Processes for producing titanium dioxide are roughly classified into a vapor-phase process and a liquid-phase process. In a vapor-phase process, a raw material such as titanium tetrachloride is gasified, and the resultant gas is reacted with an oxidative gas such as oxygen or steam. In a liquid-phase process, an aqueous solution containing, for example, titanyl sulfate is subjected to hydrolysis. In view that powder containing less amounts of aggregated particles can be produced, the vapor-phase process is superior to the liquid-phase process.

However, in the vapor-phase process, difficulty is encountered in producing particles having an average size of more than 2 μm. Meanwhile, in the liquid-phase process, the size of particles to be produced can be readily regulated within a wide range. However, in the liquid-phase process, the concentrations of generated particles and nuclei in a reaction zone are higher as compared with the case of the vapor-phase process, and thus association/growth of particles tends to occur, whereby aggregated particles are formed. Furthermore, the liquid-phase process requires steps of solid-liquid separation and drying. Liquid bridges between particles generated during solid-liquid separation cause aggregation of the particles during the course of drying.

Examples of known vapor-phase processes for producing titanium dioxide include a process disclosed in Japanese Patent Application Laid-Open (kokai) No. 6-340423 in which titanium tetrachloride is hydrolyzed in flame, to thereby produce titanium dioxide having a high rutile content, and a process disclosed in Japanese Patent Application Laid-Open (kokai) No. 7-316536 in which titanium tetrachloride is hydrolyzed in a high-temperature vapor phase, to thereby produce crystalline transparent titanium dioxide.

However, in these vapor-phase processes, difficulty is encountered in producing powder containing no aggregated particles. Examples of processes for producing powder containing relatively small amounts of aggregated particles (i.e., nearly mono-dispersed powder) include a flame fusion process in which titanium dioxide powder (raw material) is brought directly into a high-temperature flame, and the powder is melted at high temperature, to thereby produce a titanium dioxide powder product; a process in which titanium tetrachloride gas or titanium alkoxide, in place of titanium dioxide, is brought into a high-temperature flame, to thereby produce spherical titanium dioxide; and a process in which titanium dioxide serving as a raw material is fired and crushed.

Japanese Patent Application Laid-Open (kokai) No. 10-174864 discloses a typical flame fusion process employing titanium dioxide as a raw material, in which rutile-type titanium dioxide powder is brought into a high-temperature flame, to thereby produce anatase-type titanium dioxide exhibiting photocatalytic activity.

Japanese Patent Application Laid-Open (kokai) No. 2001-151509 discloses a typical process for producing spherical titanium dioxide, in which hydrogen is employed in vapor-phase reaction of titanium tetrachloride, to thereby increase the temperature of a reaction zone.

In the flame fusion process, productivity of fine particles is very low, or fine particles cannot be produced at all. In the flame fusion process, titanium dioxide serving as a raw material is brought into a flame, and titanium dioxide particles which are partially melted through heating are formed into spherical powder by means of surface tension of the particles. In the flame fusion process, titanium dioxide powder of relatively large particle size which is produced through the liquid-phase process is employed as a raw material. Fine titanium dioxide powder must be employed as a raw material for producing fine particles. However, when fine titanium dioxide powder is employed as a raw material, considerable aggregation of particles occurs. In addition, since primary particles have a small size, the particles are easily melted, and motion of the particles is promoted by flame turbulence. As a result, the frequency of association between primary particles increases, and thus large particles increase in number and growth of the particles tends to occur, whereby a large amount of air is taken into the particles during growth thereof. In the flame fusion process, when titanium dioxide powder having a relatively large particle size is employed as a raw material, spherical particles having a size nearly equal to that of the raw material powder and containing almost no pores are produced.

In the process in which a raw material such as titanium alkoxide or titanium tetrachloride is brought into a combustion flame and hydrolyzed, to thereby produce titanium dioxide, steps including generation of nuclei and growth of particles must be performed in the combustion flame, and therefore large equipment is required, although the size of particles can be increased to some extent by lengthening the high-temperature residence time of the particles by increasing the amount of a combustible gas or flame length. Particularly when titanium tetrachloride is employed as a raw material, the residence time of high-temperature chlorine gas or high-temperature hydrogen chloride gas is lengthened, whereby corrosion of a reactor or reaction equipment is promoted, making production of a high-purity product difficult. In general, large particles having a primary particle size of more than 2 μm are very difficult to grow in the above process.

As described above, in the processes employing flame, difficulty is encountered in regulating the length of a high-temperature reaction zone and the residence time of particles, leading to difficulty in regulating the particle size and increasing the purity of the particles. As a result, high-purity titanium dioxide having a particle size of some μm to some hundreds of μm is difficult to produce.

In a process through static firing, mobility of atoms is promoted at high temperature, whereby particles are grown. In the process, migration of atoms from the material constituting an apparatus to be employed is inevitable, resulting in contamination of particles with impurities. The process employing static firing requires crushing of fired particles (i.e., regulation of the particle size), and the particles are inevitably contaminated with impurities derived from a crushing medium. Examples of substances which tend to intrude particles through the static firing process include Fe, Cr, Ni, Al, Si, and Zr.

An object of the present invention is to provide high-purity titanium dioxide having an average particle size of some μm to some hundreds of μm and exhibiting high dispersibility, which is produced through a flame fusion process, which can be widely employed in industry, and which is particularly suitable as a raw material for photocatalytic powder and ceramic molded products. Another object of the present invention is to provide a process for producing the titanium dioxide.

### SUMMARY OF THE INVENTION

In view of the foregoing, the present invention has been accomplished on the basis of the results of extensive studies. The present inventors have found that, when titanium dioxide which is produced through a specific production process, which exhibits high dispersibility, and which has a specific particle size is employed as a raw material in a flame fusion process, there can be produced high-purity titanium dioxide exhibiting excellent dispersibility and containing no pores, spherical particles of the titanium dioxide are readily formed within a short high-temperature residence time, and the particle size of the titanium dioxide is readily regulated.

Accordingly, the present invention encompasses the inventions (1) through (27) described below.

(1) A titanium dioxide characterized by having an average particle size of 5 to 200 μm as measured through laser particle size analysis; having a purity of at least 99.5 mass % as reduced to TiO₂; and having an Fe content of 20 mass ppm or less, an Ni content of 20 mass ppm or less, a Cr content of 20 mass ppm or less, an Al content of 20 mass ppm or less, a Zr content of 20 mass ppm or less, an Si content of 40 mass ppm or less, a Cl content of 0.05 mass % or less, and an S content of 50 mass ppm or less.

(2) The titanium dioxide according to (1) above, which has a density of at least 3.7 g/cm³.

(3) The titanium dioxide according to (1) or (2) above, which exhibits photocatalytic activity.

(4) The titanium dioxide according to any one of (1) through (3) above, which assumes the form of particles having a spherical degree of at least 0.9 as defined by the following formula (1):
spherical degree=(the circumference of a circle having the same area as that of a projection image of a particle)/(the length of the contour of the projection image of the particle) (1).

(5) A process for producing the titanium dioxide as recited in any one of (1) through (4) above, comprising bringing titanium dioxide serving as a raw material (hereinafter may be referred to simply as “raw material titanium dioxide”) into a high-temperature flame formed by use of a combustible gas and a combustion-supporting gas, to thereby yield spherical titanium dioxide, characterized in that said raw material titanium dioxide has been produced through a vapor-phase process in which titanium tetrachloride is oxidized with an oxidative gas at high temperature.

(6) The process according to (5) above, wherein said raw material titanium dioxide has been produced by means of a vapor-phase process for producing titanium dioxide through oxidation of titanium tetrachloride with an oxidative gas, in which a titanium tetrachloride-containing gas and the oxidative gas are preliminarily heated to at least 500° C., and each of these gases is fed to a reaction tube at a flow rate of at least 10 m/second, to thereby allow reaction to proceed.

(7) The process according to (6) above, wherein reaction is performed by holding the titanium tetrachloride-containing gas and the oxidative gas in a zone of the reaction tube having a temperature higher than 600° C. for no more than three seconds.

(8) The process according to any one of (5) through (7) above, wherein the raw material titanium dioxide is titanium dioxide which has been produced through a vapor-phase process (hereinafter may be referred to simply as “vapor phase process-grown titanium dioxide”) having a particle size calculated on the basis of its BET specific surface area (hereinafter may be referred to simply as “BET-based particle size”) of 7 to 500 nm, having an average particle size of 0.4 to 10 μm as measured through laser particle size analysis, and having an Fe content of 20 mass ppm or less, an Ni content of 20 mass ppm or less, a Cr content of 20 mass ppm or less, an Al content of 20 mass ppm or less, a Zr content of 20 mass ppm or less, an Si content of 40 mass ppm or less, a Cl content of 1 mass % or less, and an S content of 200 mass ppm or less.

(9) The process according to any one of (5) through (7) above, wherein the raw material titanium dioxide is a powder mixture of vapor phase process-grown titanium dioxide having a BET-based particle size of 150 to 1,000 nm and an average particle size of 0.5 to 20 μm as measured through laser particle size analysis and vapor phase process-grown titanium dioxide having a BET-based particle size of 7 to 500 nm and having an average particle size of 0.4 to 10 μm as measured through laser particle size analysis, said vapor phase process-grown titanium dioxides having an Fe content of 20 mass ppm or less, an Ni content of 20 mass ppm or less, a Cr content of 20 mass ppm or less, an Al content of 20 mass ppm or less, a Zr content of 20 mass ppm or less, an Si content of 40 mass ppm or less, a Cl content of 1 mass % or less, and an S content of 200 mass ppm or less.

(10) The process according to any one of (5) through (9) above, wherein the raw material titanium dioxide is dispersed and transported by a turbulent carrier gas having a tube Reynolds number of at least 10,000, and brought into the high-temperature flame.

(11) The process according to (10) above, wherein the flow rate of a mixture of the raw material titanium dioxide and the carrier gas (hereinafter the mixture may be referred to simply as “raw material-carrier mixture gas”) spurted out from a nozzle is at least 8 Nm/second (wherein N refers to “normal state,” and the expression “Nm/second” refers to a flow rate obtained by dividing the amount of a gas spurted out from a nozzle at a normal state (Nm³/second) by the area of the spurt outlet of the nozzle (m²)); the flow rate of the combustible gas spurted out from a burner nozzle is 0.8 to 4 times that of the spurted raw material-carrier mixture gas; the flow rate of the oxidative gas spurted out from a burner nozzle is 1.3 to 11 times that of the spurted raw material-carrier mixture gas; and the flow rate of the spurted oxidative gas is higher than that of the Spurted combustible gas.

(12) The process according to (10) or (11) above, wherein the combustible gas is any species selected from the group consisting of methane, ethane, propane, ethylene, propylene, acetylene, butane, LPG, hydrogen, carbon monoxide, and mixtures thereof.

(13) The process according to any one of (10) through (12) above, wherein the oxidative gas contains oxygen in an amount of 15 vol. % to 100 vol. % of the oxidative gas.

(14) The process according to any one of (10) through (13) above, wherein the raw material titanium dioxide and the carrier gas are spurted out from the upstream region of the flame toward the downstream region of the combustion gas.

(15) An organic polymer composition characterized by comprising, in an organic polymer, the titanium dioxide as recited in any one of (1) through (4) above in an amount of 0.01 mass % to 80 mass % on the basis of the entire mass of the composition.

(16) The organic polymer composition according to (15) above, wherein the organic polymer of the composition is at least one species selected from the group consisting of a synthetic thermoplastic resin, a synthetic thermosetting resin, and a natural resin.

(17) The organic polymer composition according to (15) or (16) above, which is a compound.

(18) The organic polymer composition according to (15) or (16) above, which is a masterbatch.

(19) A shaped product characterized by being produced through shaping of the organic polymer composition as recited in (15) or (16) above.

(20) A slurry characterized by comprising the titanium dioxide as recited in any one of (1) through (4) above.

(21) A coating agent characterized by comprising the titanium dioxide as recited in any one of (1) through (4) above.

(22) A paint composition characterized by comprising the titanium dioxide as recited in any one of (1) through (4) above.

(23) A structure characterized by comprising, on its surface, the titanium dioxide as recited in any one of (1) through (4) above.

(24) A titanium dioxide single crystal characterized by being produced from the titanium dioxide as recited in any one of (1) through (4) above.

(25) A ceramic shaped body characterized by being produced from the titanium dioxide as recited in any one of (1) through (4) above.

(26) A dielectric raw material characterized by comprising the titanium dioxide as recited in any one of (1) through (4) above.

(27) A cosmetic composition comprising the titanium dioxide as recited in any one of (1) through (4) above.

### BRIEF DESCRIPTION OF THE DRAWINGS

FIG. 1 is a schematic representation showing an exemplary reaction apparatus for carrying out the production process for raw material titanium dioxide employed in the present invention.

FIG. 2 is a schematic representation showing an exemplary reaction apparatus for carrying out the production process of the present invention.

### DETAILED DESCRIPTION OF THE INVENTION

The present invention will next be described in detail.

Ultrafine particulate titanium dioxide having a BET-based reduced particle size of 7 to 1,000 nm, serving as a raw material, can be produced through, for example, the following procedure.

In the vapor-phase process in which titanium tetrachloride is oxidized with an oxidative gas at high temperature to thereby produce titanium dioxide, a titanium tetrachloride-containing gas and an oxidative gas are preliminarily heated to 500° C. or higher, and the thus-heated gases are fed to a reaction tube, to thereby allow reaction to proceed. In this process, each of the preliminarily heated titanium tetrachloride-containing gas and oxidative gas is fed to the reaction tube at a flow rate of 10 m/second or more. The preliminarily heated titanium tetrachloride-containing gas and oxidative gas are held in a zone of the reaction tube having a temperature of higher than 600° C. for three seconds or less, to thereby allow reaction to proceed. In this production process, preferably, the preliminarily heated titanium tetrachloride-containing gas and oxidative gas are fed to the reaction tube, to thereby generate turbulent flow in the reaction tube.

The titanium tetrachloride-containing gas and the oxidative gas may be fed to the reaction tube by use of a coaxial parallel-flow nozzle. The titanium tetrachloride-containing gas may contain titanium tetrachloride in an amount of 10 to 100%.

Characteristic features of the vapor phase process-grown titanium dioxide produced through the above production process will next be described. The vapor phase process-grown titanium dioxide has a chain structure in which primary particles are weakly point-bonded together to form a long chain. This chain structure is formed in situ; i.e., in a reaction zone in which particles are formed, and this feature is unique to the powder produced through the vapor-phase process. The length of the chain varies with the size of primary particles. Powder produced through the liquid-phase process does not have such a chain structure, and forms aggregations of primary particles.

According to the present invention, vapor phase process-grown titanium dioxide powder having a BET-based particle size of 7 to 500 nm and vapor phase process-grown titanium dioxide powder having a particle size of 150 to 1,000 nm are appropriately mixed together, or solely a vapor-grown powder is employed as a raw material, to thereby produce titanium dioxide having an average particle size of 5 to 200 μm as measured through laser particle size analysis. The particle size of the titanium dioxide product can be regulated by changing the mixing ratio of the raw materials and by regulating the combustion flame In order to produce a titanium dioxide product having a large particle size, the ratio of the titanium dioxide powder having a larger particle size may be increased.

Since titanium dioxide powder produced through the vapor-phase process has the aforementioned chain structure, the powder is suitable as a raw material for the titanium dioxide of the present invention. In the vapor-phase process, the chain structure is considered to be an aggregation unit. The structure is also considered to be a transfer unit in gas flow. Since the chain structure is formed of chains of primary particles, the powder having the chain structure is sensitive to the resistance of gas flow, and is readily transported. The powder is dispersed by the shearing force from gas flow, and then brought into a flame. When the powder is formed into spherical particles, air present between particles of the powder is readily removed. Therefore, spherical particles having a density nearly equal to the theoretical density and containing very small amounts of pores can be produced.

The thus-produced titanium dioxide usually has a density of at least 3.7 g/cm³, preferably at least 3.8 g/cm³, more preferably at least 3.9 g/cm³. The thus-produced titanium dioxide particles usually have a spherical degree of at least 0,9, preferably at least 0.95 as defined by the following formula (1):
spherical degree=(the circumference of a circle having the same area as that of a projection image of a particle)/(the length of the contour of the projection image of the particle) (1).

When the titanium dioxide powder having high spherical degree is employed in pigments or cosmetic compositions, the powder provides excellent tactile sensation and smoothness, by virtue of its high rolling performance. Since the titanium dioxide powder exhibits excellent dispersibility and fluidity, when the powder is appropriately incorporated as a ceramic raw material into other raw materials, the resultant shaped product exhibits high density. In addition, by virtue of its excellent fillability, the titanium dioxide powder can be employed as a filler in, for example, a resin. The spherical titanium dioxide powder containing small amounts of aggregated particles is very useful.

The diameter of a tube through which a carrier gas for transporting the raw material titanium dioxide passes and the flow rate of the carrier gas are determined such that the tube Reynolds number of the carrier gas becomes at least 10,000, preferably at least 15,000. When the tube Reynolds number falls within the above range, the titanium dioxide powder produced through the vapor-phase process can be dispersed efficiently by means of the carrier gas.

Titanium dioxide powder produced through the liquid-phase process assumes the form of aggregated particles, and thus has high bulk density and exhibits poor dispersibility. Therefore, when the titanium dioxide powder produced through the liquid-phase process is employed as a raw material, a technique for dispersing the powder in gas flow is required. In order to disperse such aggregated powder of low dispersibility, in general, the amount of a carrier gas is increased, to thereby increase the flow rate of the powder. As compared with titanium dioxide powder produced through the vapor-phase process, the powder produced through the liquid-phase process is not sensitive to the resistance of gas flow and to the shearing force from the gas flow. Therefore, in the case of the powder produced through the liquid phase process, the flow rate must be increased excessively. However, when the amount of the carrier gas is increased excessively, the temperature of a combustion flame is lowered due to the cooling effect of the carrier gas. In addition, an excessive amount of the carrier gas changes the shape of the flame, and lowers the temperature of a reaction zone to a level lower than necessary. When the amount of a combustible gas is increased in order to increase the temperature of the reaction zone, a high-temperature zone becomes large, and thus difficulty is encountered in regulating the particle size. In the case where the powder produced through the liquid-phase process, which contains large amounts of aggregated particles, is brought into the reaction zone, the resultant titanium dioxide powder contains air bubbles and has low density.

When titanium dioxide powder produced through the vapor-phase process is brought into a high-temperature zone, the powder is melted and shrunk through the application of heat. In this case, one chain structure is considered to form one spherical particle. The titanium dioxide powder produced through the vapor-phase process contains small-sized primary particles, and therefore, at a relatively low temperature, the powder is readily melted and spherical particles are readily formed. Therefore, when the vapor phase process-grown titanium dioxide powder is employed as a raw material, even if the amount of combustion of flame gas is lowered, spherical titanium dioxide can be produced.

In general, in a high-temperature flame, association and growth of a plurality of spherical particles occur, to thereby form large-sized particles. However, the titanium dioxide powder produced through the vapor-phase process is melted at a relatively low flame temperature, and the powder having the aforementioned chain structure is dispersed efficiently. Therefore, in the case of the vapor phase process-grown titanium dioxide powder, association and growth of melted particles tend not to occur. As a result, fine particles having a narrow particle size distribution width; i.e., fine particles having a sharp particle size distribution, are produced.

Employment of titanium dioxide powder having a broad particle size distribution is not preferred. For example, when such powder is employed as a ceramic raw material, the resultant sintered product has a non-uniform structure, and thus the product exhibits low bending strength. When titanium dioxide powder is employed as a resin filler, the powder preferably has a sharp particle size distribution, since the particle size of the powder is regulated in order to enhance its fillability.

In order to prevent production of titanium dioxide powder having a broad particle size distribution, preferably, the residence time of raw materials in a high-temperature zone is shortened to the lowest level possible. As described above, in the high-temperature zone, spherical particles are formed, and association and growth of particles occur. In order to produce titanium dioxide having a narrow particle size distribution, preferably, the temperature of a combustion zone is regulated such that spherical particles are formed, but a association and growth of particles does not occur. However, reaction and particle growth in the combustion zone are affected by various factors, including properties of raw materials and flame conditions. Therefore, conventionally, difficulty has been encountered in regulating the temperature of the combustion zone so as to prevent occurrence of association and growth of particles. In the present invention, the temperature of a high-temperature zone is lowered by regulating the ratio between the flow rates of a combustible gas, an oxidative gas, and a carrier gas, and vapor phase process-grown titanium dioxide powder having a chain structure and containing small-sized primary particles is employed as a raw material, to thereby solve the aforementioned problems.

A merit of the process of the present invention resides in that the particle size distribution of titanium dioxide powder can be regulated, along with reduction of the amount of impurities.

A combustion flame is generally produced by use of a burner. When a burner is ignited, the temperature of a reaction apparatus changes drastically. Therefore, a ceramic material, which is a typical heat-resistant material, is not suitable for forming members constituting the apparatus. In general, since a metallic material is employed in the members of the apparatus, the members are softened by a high-temperature flame and wear of the members occurs, and a product is contaminated with impurities. However, in the present invention, titanium dioxide powder produced through the vapor-phase process, which is readily transported by means of gas flow, is employed as a raw material. Therefore, since the temperature of a flame is regulated to a low level, the temperature of the apparatus is lowered, and wear of the members of the apparatus can be reduced, whereby the amount of impurities attributed to such wear is lowered.

The structure of a burner to be employed is preferably determined such that the purity of a product is not lowered even when a reaction apparatus formed of metallic members is employed. The burner preferably has a coaxial triple-tube structure. In the burner having such a structure, raw material titanium dioxide and a carrier gas (e.g., air or nitrogen) for transporting the titanium dioxide are caused to pass through the innermost tube; a fuel gas (combustible gas) such as LPG is caused to pass through the middle tube; and an oxidative gas such as oxygen or air is caused to pass through the outermost tube. The flow rate of the raw material-carrier gas spurted out from a burner nozzle is at least 8 Nm/second (wherein N refers to “normal state,” and the expression “Nm/second” refers to a flow rate obtained by dividing the amount of a gas spurted out from a nozzle at a normal state (Nm³/second) by the area of the spurt outlet of the nozzle (m²), the same shall apply hereinafter), preferably 8 Nm/second to 50 Nm/second inclusive. The diameter of the innermost tube is determined such that the tube Reynolds number becomes at least 10,000, preferably at least 15,000. Under the above conditions, the raw material titanium dioxide powder can be dispersed sufficiently. The flow rate of the combustible gas spurted out from a burner nozzle is determined to be 0.8 to 4 times, preferably 0.9 to 3 times, that of the raw material-carrier gas spurted out from the innermost tube. The flow rate of the oxidative gas spurted out from a burner nozzle is determined to be 1.3 to 11 times, preferably 3 to 6 times, that of the spurted raw material-carrier gas. When the flow rates of these gases are regulated as described above, the shape of a combustion flame can be maintained suitable for producing the powder (titanium dioxide) of the present invention. Under the aforementioned conditions, the resultant titanium dioxide product is contaminated with almost no impurities such as Fe, Ni, Cr, Si, Al, and Zr, and the amount of impurities contained in the products becomes equivalent to that of impurities contained in the raw material titanium dioxide. Therefore, in order to produce a high-purity product, preferably, high-purity raw material titanium dioxide is employed.

When raw material titanium dioxide is melted in a high-temperature flame, impurities contained in the titanium dioxide, such as Cl and S, form gases such as HCl, Cl₂, and SO₂. When a combustion zone is formed of stainless steel, the zone is corroded by such gases, to thereby generate large amounts of impurities such as Fe. Therefore, the raw material titanium dioxide preferably contains less amounts of Cl and S. The purity of the raw material titanium dioxide is preferably at least 99.5 mass % as reduced to TiO₂. Each of the Fe, Ni, Cr, Al, and Zr contents of the titanium dioxide is 20 mass ppm or less, preferably 10 mass ppm or less. The Si content of the titanium dioxide is 40 mass ppm or less, preferably 20 mass ppm or less. The Cl content of the titanium dioxide is 1 mass % or less, preferably 0.2 mass % or less. The S content of the titanium dioxide is 200 mass ppm or less, preferably 100 mass ppm or less.

The thus-produced spherical titanium dioxide is collected by use of, for example, a bag filter, whereby the final product is obtained.

When the aforementioned raw material titanium dioxide is employed, the resultant titanium dioxide product has a purity of at least 99.5 mass % as reduced to TiO₂. Each of the Fe, Ni, Cr, Al, and Zr contents of the titanium dioxide product is 20 mass ppm or less, preferably 10 mass ppm or less, more preferably 5 mass ppm or less. The Si content of the titanium dioxide product is 40 mass ppm or less, preferably 20 mass ppm or less, more preferably 10 mass ppm or less. The Cl content of the titanium dioxide product is 1 mass % or less, preferably 0.5 mass % or less, more preferably 0.2 mass % or less. The S content of the titanium dioxide product is 200 mass ppm or less, preferably 100 mass ppm or less, more preferably 80 mass ppm or less.

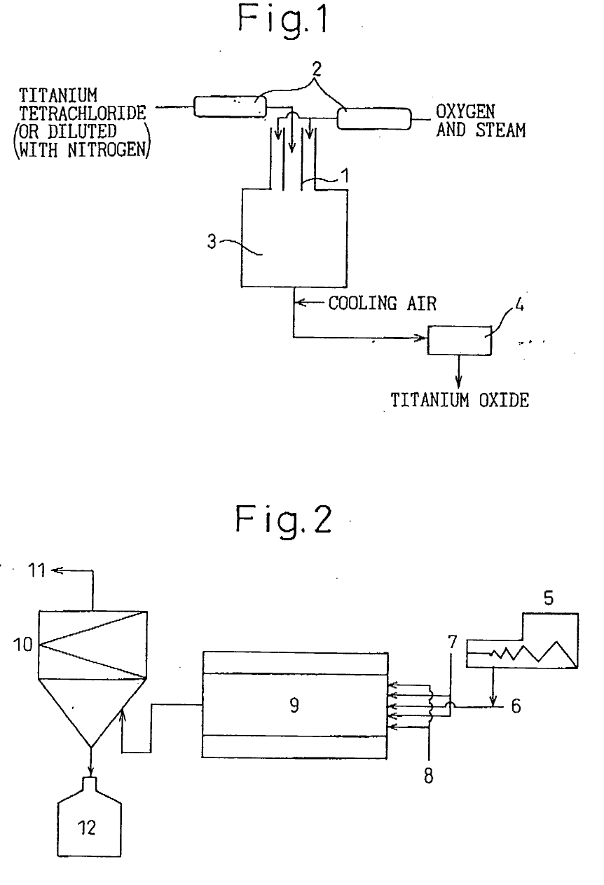

FIG. 1 schematically shows a typical production apparatus for producing vapor phase process-grown titanium dioxide employed as a raw material in the present invention. FIG. 2 schematically shows a typical production apparatus for carrying out the present invention. The present invention will next be described with reference to these figures.

The apparatus shown in FIG. 1 will now be described. In FIG. 1, reference numeral 1 denotes a coaxial parallel-flow nozzle section, 2 preheaters, 3 a reaction tube, and 4 a bag filter. Raw material titanium dioxide is produced through a typical process flow depicted in FIG. 1.

The apparatus shown in FIG. 2 will now be described. In FIG. 2, reference numeral 5 denotes a feeder/hopper for feeding a predetermined amount of vapor phase process-grown titanium dioxide serving as a raw material. The feed amount of the raw material is determined arbitrarily. When the feed amount and the particle size of the raw material are large, the tube Reynolds number of a carrier gas must be increased.

Reference numeral 6 denotes a carrier gas for transporting the raw material powder into a flame. For example, air or nitrogen gas is employed as the carrier gas. The raw material titanium dioxide supplied from the raw material feeder 5 is dispersed and transported by the carrier gas, and then brought into the flame. The carrier gas must assume a turbulent state for dispersing the raw material powder. The diameter of a tube through which the carrier gas passes and the flow rate of the carrier gas are determined such that the tube Reynolds number of the carrier gas becomes at least 10,000, preferably at least 15,000.

Reference numeral 7 denotes a combustible gas for forming a combustion flame. No particular limitations are imposed on the combustible gas, so long as the gas exhibits combustibility. Preferred examples of the combustible gas include methane, ethane, propane, ethylene, propylene, acetylene, butane, LPG, hydrogen, carbon monoxide, and mixtures thereof. Of these, LPG is more preferred. The flow rate of the spurted carrier gas is at least 8 Nm/second, and the flow rate of the combustible gas spurted out from a burner nozzle is preferably 0.8 to 4 times that of the carrier gas.

Reference numeral 8 denotes a combustion-supporting gas (may be referred to as “oxidative gas”). No particular limitations are imposed on the oxidative gas, so long as the gas contains oxygen. The oxidative gas is preferably oxygen. The flow rate of the oxidative gas spurted out from a burner nozzle is 1.3 to 11 times that of the carrier gas, and the spurt flow rate of the oxidative gas is preferably higher than that of the combustible gas. The carrier gas containing the raw material powder, the combustible gas, and the combustion-supporting gas are brought into a combustion tube by use of a coaxial triple-tube nozzle, to thereby form a flame. In order to form a stable flame, preferably, a coaxial triple-tube burner is employed; the carrier gas is caused to flow through the innermost tube, the oxidative gas is caused to flow through the outermost tube, and the combustible gas is caused to flow through the middle tube.

A combustion flame is formed in a combustion tube 9. Since the temperature of the combustion tube changes drastically, the tube is preferably formed of, for example, stainless steel and equipped with a water cooling jacket. A ceramic tube is not suitable as the combustion tube, since it does not exhibit resistance to drastic change in temperature.

Fine powder produced in the combustion tube is trapped in a bag filter 10, and a final product is collected in a product hopper 12. A combustion exhaust gas 11 is discharged to the outside of the apparatus.

The titanium dioxide of the present invention can be employed as a photocatalytic material, as an additive to resin products, rubber products, paper, paint, and printing ink; and employed in, for example, cosmetic compositions, ceramic products, electronic parts, and rutile single-crystal raw materials. Particularly, the titanium dioxide is suitable for use in materials requiring dispersibility to a medium, fillability, and high purity.

The titanium dioxide of the present invention may be added to, for example, an organic polymer to thereby prepare a composition. Examples of the organic polymer include synthetic thermoplastic resin, synthetic thermosetting resin, and natural resin. Specific examples of the organic polymer include polyolefins such as polyethylene, polypropylene, and polystyrene; polyamides such as nylon 6, nylon 66, and aramid; polyesters such as polyethylene terephthalate and unsaturated polyesters; polyvinyl chloride; polyvinylidene chloride; polyethylene oxide; polyethylene glycol; silicone resin; polyvinyl alcohol; vinylacetal resin; polyacetate; ABS resin; epoxy resin; vinyl acetate resin; cellulose derivatives such as cellulose and rayon; urethane resin; polycarbonate; urea resin; fluorine-containing resin; polyvinylidene fluoride; phenolic resin; celluloid; chitin; starch sheet; acrylic resin; melamine resin; and alkyd resin.

The organic polymer composition containing the titanium dioxide of the present invention may be employed in the form of, for example, a paint composition (coating composition), a compound (e.g., a resin composition containing the titanium dioxide powder), or a masterbatch for a molded product containing a large amount of the titanium dioxide. The organic polymer composition may contain additives such as an antioxidant, an antistatic agent, and a fatty acid metallic salt.

The amount of the titanium dioxide of the present invention in the organic polymer composition is preferably 0.01 to 80 mass %, more preferably 1 to 50 mass %, on the basis of the entirety of the composition.

The polymer composition is subjected to molding, to thereby form a shaped product exhibiting ultraviolet shielding ability. Examples of the shaped product include fiber, film, and plastic shaped products.

When the titanium dioxide of the present invention is dispersed in water or an organic solvent, and subsequently a binder is arbitrarily added to the resultant mixture, a coating agent can be prepared. No particular limitations are imposed on the binder material, and the binder material may be an organic or inorganic binder.

Examples of the organic binder include polyvinyl alcohol, melamine resin, urethane resin, celluloid, chitin, starch sheet, polyacrylamide, acrylamide, polyesters such as unsaturated polyesters, polyvinyl chloride, polyvinylidene chloride, polyethylene oxide, polyethylene glycol, silicone resin, vinylacetal resin, epoxy resin, vinyl acetate resin, urethane resin, urea resin, fluorine-containing resin, polyvinylidene fluoride, and phenolic resin. Examples of the inorganic binder include zirconium compounds such as zirconium oxychloride, zirconium hydroxychloride, zirconium nitrate, zirconium sulfate, zirconium acetate, ammonium zirconium carbonate, and zirconium propionate; silicon compounds such as alkoxysilane and silicate; and alkoxides of metals such as aluminum and titanium.

Specifically, the amount of the binder contained in the coating agent is preferably 0.01 mass % to 20 mass %, more preferably 1 mass % to 10 mass %.

When the amount of the binder is less than 0.01 mass %, adhesion of the coating agent becomes insufficient after coating, whereas when the amount of the binder exceeds 20 mass %, problems such as thickening of the agent arise, along with economical disadvantages.

The titanium dioxide of the present invention may be applied to the surface of a structure. No particular limitations are imposed on the structure to which the titanium dioxide may be applied. For example, the structure may be formed from an inorganic substance such as metal, concrete, glass, or ceramic; or an organic substance such as paper, plastic, timber, or leather. Alternatively, the structure may be formed from a combination of an inorganic substance and an organic substance. Examples of the structure include building materials, machinery, vehicles, glass products, electric appliances, agricultural materials, electronic apparatus, tools, tableware, bath products, toiletry products, furniture, clothing, cloth products, fibers, leather products, paper products, sporting goods, futon, containers, eyeglasses, signboards, piping, wiring, brackets, sanitary materials, and automobile parts.

No particular limitations are imposed on the method for applying the titanium dioxide to the surface of a structure. For example, the aforementioned organic polymer composition or coating agent may be applied directly to a structure, or may be applied onto a structure having a coating film thereon. In addition, another coating film may be formed on the structure coated with the titanium dioxide.

### EXAMPLES

The present invention will next be described by way of Examples, which should not be construed as limiting the invention thereto.

### Example 1

Gaseous titanium tetrachloride (concentration: 100%) was preliminarily heated to 1,000° C. Separately, a gas mixture of oxygen (96 vol. %) and steam (4 vol. %) was preliminarily heated to 1,000° C. The titanium tetrachloride gas and the gas mixture were brought into a reaction tube through a coaxial parallel-flow nozzle at flow rates of 49 m/second and 50 m/second, respectively. Reaction was performed in the production apparatus shown in FIG. 1, and the titanium tetrachloride gas was fed through the inner tube. The flow rates of the titanium tetrachloride gas and the gas mixture in the reaction tube were found to be 8 m/second (calculated value) at a reaction temperature of 1,630° C. After completion of reaction, cooling air was brought into the reaction tube such that the high-temperature residence time of the resultant reaction mixture was 0.1 seconds or less in the reaction tube. Thereafter, the thus-produced titanium dioxide powder was collected by use of a polytetrafluoroethylene-made bag filter.

The thus-produced titanium dioxide powder was found to have a BET-based particle size of 300 nm and an average particle size of 0.6 μm as measured through laser particle size analysis. By use of a plasma atomic emission spectrometer (model: ICPS-7500, product of Shimadzu Corporation), the Fe, Al, and Si contents of the titanium dioxide powder were measured, and found to be 5 mass ppm, 3 mass ppm, and 15 mass ppm, respectively. Each of the Cr, Ni, and Zr contents of the titanium dioxide powder was found to be at or below the detection limit (1 mass ppm). The Cl content of the titanium dioxide powder was measured by use of an automatic titration apparatus (model: C-500, product of Hiranuma Sangyo Co., Ltd.), and found to be 0.01 mass %. The titanium dioxide powder was employed as a raw material.

Subsequently, LPG was spurted out from the nozzle of the middle tube of a coaxial triple-tube burner at a flow rate of 90 NM/second, and oxygen was spurted out from the nozzle of the outermost tube of the burner at a flow rate of 200 Nm/second, to thereby form a combustion flame.

The raw material titanium dioxide was fed through the innermost tube at a feed rate of 6 kg/hour together with air serving as a carrier gas, and spurted out from the nozzle of the tube to the combustion flame. The flow rate of the air spurted out from the nozzle was 40 Nm/second, and the tube Reynolds number of the air was 43,000. The thus-combusted gas containing solids was fed to a bag filter, to thereby collect powder. The thus-obtained powder assumed a white color and a spherical shape. The particle size of the powder was measured by use of a laser particle size analyzer (model: SALD-2000J, product of Shimadzu Corporation), and the average particle size of the powder was found to be 160 μm. The Fe content of the powder was measured by use of a plasma atomic emission spectrometer (model: ICPS-7500, product of Shimadzu Corporation), and found to be 8 mass ppm. Also, the Cr, Ni, Al, Si, and Zr contents of the powder were measured. As a result, the Al and Si contents were found to be the same as those of the raw material, and each of the Cr, Ni, and Zr contents was found to be at or below the detection limit. The S content of the powder was also measured, and found to be 6 mass ppm. The Cl content of the powder was measured by use of an automatic titration apparatus (model: C-500, product of Hiranuma Sangyo Co., Ltd.), and found to be 0.003 mass %. The specific gravity of the powder was measured by means of the specific gravity bottle method as specified by JIS Z 8807. The density of the powder was calculated on the basis of the thus-measured specific gravity, and found to be 3.98 g/cm³. The spherical degree of the powder was obtained through the following procedure: 300 to 500 particles of the powder were photographed by use of a scanning electron microscope, and the thus-obtained micrograph was analyzed by use of an image analysis apparatus (model: LUZEX 5000, product of NIRECO). Particles having a spherical degree of 0.9 or less were not observed, and the simple average spherical degree was calculated to be 0.95.

### Example 2

A gas containing gaseous titanium tetrachloride (23 vol. %) and nitrogen (77 vol. %) was preliminarily heated to 1,100° C. Separately, an oxidative gas containing air (45 vol. %) and steam (55 vol. %) was preliminarily heated to 1,000° C. The titanium-tetrachloride-containing gas and the oxidative gas were brought into a reaction tube through a coaxial parallel-flow nozzle at flow rates of 92 m/second and 97 m/second, respectively. The titanium-tetrachloride-containing gas was fed through the inner tube. The flow rates of the titanium-tetrachloride-containing gas and the oxidative gas in the reaction tube were found to be 13 m/second (calculated value) at a reaction temperature of 1,250° C. After completion of reaction, cooling air was brought into the reaction tube such that the high-temperature residence time of the resultant reaction mixture was 0.2 seconds in the reaction tube. Thereafter, the thus-produced titanium dioxide powder was collected by use of a polytetrafluoroethylene-made bag filter.

The thus-produced titanium dioxide powder was found to have a BET-based particle size of 10 nm and an average particle size of 0.16 μm as measured through laser particle size analysis. The Fe, Cr, Ni, Al, Si, and Zr contents of the titanium dioxide powder were measured by use of a plasma atomic emission spectrometer (model: ICPS-7500, product of Shimadzu Corporation). As a result, the Fe, Al, and Si contents of the powder were found to be 3 mass ppm, 3 mass ppm, and 26 mass ppm, respectively. Each of the Cr, Ni, and Zr contents of the powder was found to be at or below the detection limit. The Cl content of the titanium dioxide powder was measured by use of an automatic titration apparatus (model: C-500, product of Hiranuma Sangyo Co., Ltd.), and found to be 0.8 mass %. The titanium dioxide powder was employed as a raw material.

LPG was spurted out from the nozzle of the middle tube of a coaxial triple-tube burner at a flow rate of 25 Nm/second, and oxygen was spurted out from the nozzle of the outermost tube of the burner at a flow rate of 105 Nm/second, to thereby form a combustion flame.

Subsequently, the raw material titanium dioxide was fed through the innermost tube at a feed rate of 2 kg/hour together with air serving as a carrier gas, and spurted out from the nozzle of the tube. The flow rate of the air spurted out from the nozzle was 23 Nm/second, and the tube Reynolds number of the air was 23,000. The thus-combusted gas containing solids was fed to a bag filter, to thereby collect powder. The thus-obtained powder assumed a white color and a spherical shape. The particle size of the powder was measured by use of a laser particle size analyzer (model: SALD-2000J, product of Shimadzu Corporation), and the average particle size of the powder was found to be 9 μm. The Fe, Cr, Ni, Al, Si, and Zr contents of the powder were measured by use of a plasma atomic emission spectrometer (model: ICPS-7500, product of Shimadzu Corporation). As a result, the Fe, Al, and Si contents were found to be 7 mass ppm, 3 mass ppm, and 26 mass ppm, respectively. Each of the Cr, Ni, and Zr contents of the powder was found to be at or below the detection limit. The S content of the powder was also measured, and found to be 5 mass ppm. The Cl content of the powder was measured by use of an automatic titration apparatus (model; C-500, product of Hiranuma Sangyo Co., Ltd.), and found to be 0.02 mass %. The density and spherical degree of the powder were measured in manners similar to those of Example 1, and found to be 3.75 g/cm³ and 0.96, respectively.

### Example 3

LPG was spurted out from the nozzle of the middle tube of a coaxial triple-tube burner at a flow rate of 45 Nm/second, and oxygen was spurted out from the nozzle of the outermost tube of the burner at a flow rate of 115 Nm/second, to thereby form a combustion flame.

Subsequently, the raw material titanium dioxide (BET-based particle size: 300 nm) employed in Example 1 and the raw-material titanium dioxide (BET-based particle size: 10 nm) employed in Example 2 were mixed at a ratio by mass of 1:1. The resultant mixture was fed through the innermost tube at a feed rate of 3 kg/hour together with nitrogen serving as a carrier gas, and spurted out from the nozzle of the tube. The flow rate of the nitrogen spurted out from the nozzle was 30 Nm/second, and the tube Reynolds number of the nitrogen was 31,000. The thus-combusted gas containing solids was fed to a bag filter, to thereby collect powder. The thus-obtained powder assumed a white color. The particle size of the powder was measured by use of a laser particle size analyzer (model: SALD-2000J, product of Shimadzu Corporation), and the average particle size of the powder was found to be 90 μm. By use of a plasma atomic emission spectrometer (model: ICPS-7500, product of Shimadzu Corporation), the Fe and S contents of the powder were measured, and found to be 6 mass ppm and 6 mass ppm, respectively. Also, the Cr, Ni, Al, Si, and Zr contents of the powder were measured. As a result, the Al and Si contents were found to be 3 mass ppm and 20 mass ppm, respectively, and each of the Cr, Ni, and Zr contents of the powder was found to be at or below the detection limit. The Cl content of the powder was measured by use of an automatic titration apparatus (model: C-500, product of Hiranuma Sangyo Co., Ltd.), and found to be 60 mass ppm. The density and spherical degree of the powder were measured in manners similar to those of Example 1, and found to be 3.84 g/cm³ and 0.92, respectively.

### Example 4

The spherical titanium dioxide powder produced in Example 3 (average particle size: 90 μm) (8 g) was mixed with pure water (76 g), to thereby prepare a slurry. An acrylic-silicone resin emulsion (SX8172(A)-01, product of JSR Corporation) (16 g), serving as a binder, was added to the thus-prepared slurry, to thereby prepare spherical-titanium-dioxide-containing coating agent A.

The raw material titanium dioxide employed in Example 3 (BET-based particle size; 300 nm) and raw material titanium dioxide (BET-based particle size: 100 nm) were mixed at a ratio by mass of 1:1. The resultant powder mixture (8 g) was mixed with pure water (76 g), to thereby prepare a slurry. An acrylic-silicone resin emulsion (SX8172(A)-01, product of JSR Corporation) (16 g), serving as a binder, was added to the thus-prepared slurry, to thereby prepare titanium dioxide-containing coating agent B.

Subsequently, polyester non-woven fabrics (Marix 10706WTD, product of Unitika Ltd.) were impregnated with these two coating agents, and the resultant fabrics were squeezed by use of a roller, followed by natural drying for 24 hours, to thereby prepare non-woven fabric sample A (coated with spherical-titanium-dioxide-containing coating agent A) and non-woven fabric sample B (coated with titanium dioxide-containing coating agent B). Each of the non-woven fabrics was weighed before and after coating, and the amount of titanium dioxide applied to the fabric was calculated on the basis of an increase in mass of the fabric. The results are shown in Table 1.

Each of the above-prepared non-woven fabric samples was cut into a piece measuring 210 mm×300 mm, the piece was placed in a Tedler bag (AAK-5, product of GL Sciences Inc; capacity: 5 L), and the bag was filled with dried air (5 L) containing 60 vol. ppm hydrogen sulfide. Subsequently, the non-woven fabric sample piece was irradiated with UV rays for four hours by use of Black Light (FL205. BL, 20 W) (product of Hitachi Ltd.) such that the intensity of UV rays at 365 nm was 0.5 mW/cm². After the four-hour irradiation, the concentration of the hydrogen sulfide was measured by use of a detector tube (No. 4LL, product of Gastec Corporation). The results are shown in Table 1.

Each of the above non-woven fabric samples was irradiated with light of 50 mW/cm² for 24 hours by use of a promotion exposure apparatus (Suntest CPS+, product of ATLAS). After the 24-hour irradiation, coloring of the fabric sample was observed. The results are shown in Table 1. The results show that the titanium dioxide powder produced through the process of the present invention exhibits excellent photocatalytic activity.

TABLE 1

| | | Hydrogen sulfide | |
|---|---|---|---|
| | Amount of | concentration | |
| Non-woven | applied titanium | after four | |
| fabric sample | dioxide | hours | Coloring |
| A | 6 g/m² | 24 vol. ppm | No coloring |
| B | 7 g/m² | 54 vol. ppm | Yellowing |

### Comparative Example 1

A titanyl sulfate aqueous solution containing TiO₂ (200 g/l) was heated to 80° C., and an NaOH aqueous solution was added dropwise to the titanyl sulfate aqueous solution under stirring until the pH of the solution became 4, followed by aging at 80° C. for 30 minutes. The resultant solution was added to a titanyl sulfate aqueous solution containing TiO₂ (200 g/l) such that the amount of added TiO₂ was 0.4 mass %. The resultant mixture was heated under stirring, and boiled for six hours, to thereby perform hydrolysis. Thereafter, the resultant reaction mixture was subjected to filtration and washing with water, to thereby yield a solid product. The thus-yielded solid product was fired in an externally heated rotary kiln, to thereby produce titanium dioxide having a BET-based particle size of 150 nm and an average particle size of 250 nm as measured through laser particle size analysis.

LPG was spurted out from the nozzle of the middle tube of a coaxial triple-tube burner at a flow rate of 90 Nm/second, and oxygen was spurted out from the nozzle of the outermost tube of the burner at a flow rate of 210 Nm/second, to thereby form a combustion flame.

Subsequently, the titanium dioxide produced through the aforementioned liquid-phase process (BET-based particle size; 150 nm, average particle size as measured through laser particle size analysis: 250 nm) was fed through the innermost tube at a feed rate of 3 kg/hour together with air serving as a carrier gas, and spurted out from the nozzle of the tube. The titanium dioxide was found to contain S in an amount of 40 mass ppm and Fe in an amount of 10 mass ppm. The flow rate of the air spurted out from the nozzle was 60 Nm/second, and the tube Reynolds number of the air was 62,000. The thus-combusted gas containing solids was fed to a bag filter, to thereby collect powder. The thus-obtained powder assumed a white color. The particle size of the powder was measured by use of a laser particle size analyzer (model; SALD-2000J, product of Shimadzu Corporation), and the average particle size of the powder was found to be 310 μm. The powder was found to contain particles of irregular shape which had possibly been formed through incomplete melting and fusion. The Fe and S contents of the powder were measured by use of a plasma atomic emission spectrometer (model: ICPS-7500, product of Shimadzu Corporation), and found to be 350 mass ppm and 35 mass ppm, respectively. The density and spherical degree of the powder were measured in manners similar to those of Example 1, and found to be 3.52 g/cm³ and 0.76, respectively.

### Comparative Example 2

A titanyl sulfate aqueous solution containing TiO₂ (200 g/l) was heated to 80° C., and an NaOH aqueous solution was added dropwise to the titanyl sulfate aqueous solution under stirring until the pH of the solution became 4, followed by aging at 80° C. for 30 minutes. The resultant solution was added to a titanyl sulfate aqueous solution containing TiO₂ (200 g/l) such that the amount of added TiO₂ was 1 mass %. The resultant mixture was heated under stirring, and boiled for four hours, to thereby perform hydrolysis. Thereafter, the resultant reaction mixture was subjected to filtration and washing with water, to thereby yield a solid product. The thus-yielded solid product was fired in an externally heated rotary kiln, to thereby produce titanium dioxide having a BET-based particle size of 50 nm and an average particle size of 400 nm as measured through laser particle size analysis.

LPG was spurted out from the nozzle of the middle tube of a coaxial triple-tube burner at a flow rate of 25 Nm/second, and oxygen was spurted out from the nozzle of the outermost tube of the burner at a flow rate of 105 Nm/second, to thereby form a combustion flame.

Subsequently, the titanium dioxide produced through the above liquid-phase process (BET-based particle size: 50 nm, average particle size as measured through laser particle size analysis: 400 nm) was fed through the innermost tube at a feed rate of 3 kg/hour together with air serving as a carrier gas, and spurted out from the nozzle of the tube. The flow rate of the air spurted out from the nozzle was 40 Nm/second, and the tube Reynolds number of the air was 46,000. The thus-combusted gas containing solids was fed to a bag filter, to thereby collect powder. The thus-obtained powder assumed a white color. The particle size of the powder was measured by use of a laser particle size analyzer (model: SALD-2000J, product of Shimadzu Corporation), and the average particle size of the powder was found to be 220 μm. The Fe and S contents of the powder were measured by use of a plasma atomic emission spectrometer (model: ICPS-7500, product of Shimadzu Corporation), and found to be 200 mass ppm and 10 mass ppm, respectively. The density and spherical degree of the powder were measured in a manner similar to that of Example 1, and found to be 3.32 g/cm³ and 0.80, respectively.

### Comparative Example 3

The titanium dioxide employed in Example 1 (BET-based particle size: 300 nm, average particle size as measured through laser particle size analysis: 0.6 μm) was placed in a quartz-made container, and then subjected to static firing in an electric furnace at 1,100° C. for 48 hours. The resultant titanium dioxide was crushed by use of a mortar, to thereby produce white powder. The particle size of the powder was measured by use of a laser particle size analyzer (model; SALD-2000J, product of Shimadzu Corporation), and the average particle size of the powder was found to be 20 μm. The Fe and Si contents of the powder were measured by use of a plasma atomic emission spectrometer (model: ICPS-7500, product of Shimadzu Corporation), and found to be 10 mass ppm and 60 mass ppm, respectively. The density and spherical degree of the powder were measured in manners similar to those of Example 1, and found to be 3.85 g/cm³ and 0.88, respectively.

### INDUSTRIAL APPLICABILITY

The titanium dioxide of the present invention has an average particle size of 5 μm to 200 μm, and can be widely employed in industry. Since the titanium dioxide has high purity and exhibits excellent dispersibility, the titanium dioxide is suitable for use in, for example, organic polymer compositions, paints, and cosmetic compositions. In addition, the titanium dioxide is very useful as, for example, powder for photocatalysts, a raw material for ceramic molded products, a dielectric raw material, and a raw material for rutile single crystals. The present invention provides titanium dioxide exhibiting excellent dispersibility and high purity, and a process for producing the titanium oxide.

1. A titanium dioxide characterized by having an average particle size of 5 to 200 μm as measured through laser particle size analysis; having a purity of at least 99.5 mass % as reduced to TiO₂; and having an Fe content of 20 mass ppm or less, an Ni content of 20 mass ppm or less, a Cr content of 20 mass ppm or less, an Al content of 20 mass ppm or less, a Zr content of 20 mass ppm or less, an Si content of 40 mass ppm or less, a Cl content of 0.05 mass % or less, and an S content of 50 mass ppm or less.

2. The titanium dioxide according to claim 1, which has a density of at least 3.7 g/cm³.

3. The titanium dioxide according to claim 1 or 2, which exhibits photocatalytic activity.

4. The titanium dioxide according to any one of claims 1 through 3, which assumes the form of particles having a spherical degree of at least 0.9 as defined by the following formula (1);
spherical degree=(the circumference of a circle having the same area as that of a projection image of a particle)/(the length of the contour of the projection image of the particle) (7).

5. A process for producing the titanium dioxide as recited in any one of claims 1 through 4, comprising bringing titanium dioxide serving as a raw material into a high-temperature flame formed by use of a combustible gas and a combustion-supporting gas, to thereby yield spherical titanium dioxide, characterized in that said raw material titanium dioxide has been produced through a vapor-phase process in which titanium tetrachloride is oxidized with an oxidative gas at high temperature.

6. The process according to claim 5, wherein said raw material titanium dioxide has been produced by means of a vapor-phase process for producing titanium dioxide through oxidation of titanium tetrachloride with an oxidative gas, in which a titanium tetrachloride-containing gas and the oxidative gas are preliminarily heated to at least 500° C., and each of these gases is fed to a reaction tube at a flow rate of at least 10 m/second, to thereby allow reaction to proceed.

7. The process according to claim 6, wherein said reaction is performed by holding the titanium tetrachloride-containing gas and the oxidative gas in a zone of the reaction tube having a temperature higher than 600° C. for no more than three seconds.

8. The process according to any one of claims 5 through 7, wherein said raw material titanium dioxide is titanium dioxide produced through a vapor-phase process having a particle size calculated on the basis of its BET specific surface area of 7 to 500 nm, having an average particle size of 0.4 to 10 μm as measured through laser particle size analysis, and having an Fe content of 20 mass ppm or less, an Ni content of 20 mass ppm or less, a Cr content of 20 mass ppm or less, an Al content of 20 mass ppm or less, a Zr content of 20 mass ppm or less, an Si content of 40 mass ppm or less, a Cl content of 1 mass % or less, and an S content of 200 mass ppm or less.

9. The process according to any one of claims 5 through 7, wherein said raw material titanium dioxide is a powder mixture of titanium dioxide produced through a vapor-phase process and having a BET-based particle size of 150 to 1,000 nm and an average particle size of 0.5 to 20 μm as measured through laser particle size analysis and titanium dioxide produced through vapor-phase process and having a BET-based particle size of 7 to 500 nm and having an average particle size of 0.4 to 10 μm as measured through laser particle size analysis, said titanium dioxides produced through vapor-phase process and having an Fe content of 20 mass ppm or less, an Ni content of 20 mass ppm or less, a Cr content of 20 mass ppm or less, an Al content of 20 mass ppm or less, a Zr content of 20 mass ppm or less, an Si content of 40 mass ppm or less, a Cl content of 1 mass % or less, and an S content of 200 mass ppm or less.

10. The process according to any one of claims 5 through 9, wherein said raw material titanium dioxide is dispersed and transported by a turbulent carrier gas having a tube Reynolds number of at least 10,000, and brought into the high-temperature flame.

11. The process according to claim 10, wherein the flow rate of a mixture of the raw material titanium dioxide and the carrier gas spurted out from a nozzle is at least 8 Nm/second; the flow rate of the combustible gas spurted out from a burner nozzle is 0.8 to 4 times that of the spurted raw material-carrier mixture gas; the flow rate of the oxidative gas spurted out from a burner nozzle is 1.3 to 11 times that of the spurted raw material-carrier mixture gas; and the flow rate of the spurted oxidative gas is higher than that of the spurted combustible gas.

12. The process according to claim 10 or 11, wherein the combustible gas is any species selected from the group consisting of methane, ethane, propane, ethylene, propylene, acetylene, butane, LPG, hydrogen, carbon monoxide, and mixtures thereof.

13. The process according to any one of claims 10 through 12, wherein the oxidative gas contains oxygen in an amount of 15 vol. % to 100 vol. % of the oxidative gas.

14. The process according to any one of claims 10 through 13, wherein the raw material titanium dioxide and the carrier gas are spurted out from the upstream region of the flame toward the downstream region of the combustion gas.

15. An organic polymer composition characterized by comprising, in an organic polymer, the titanium dioxide as recited in any one of claims 1 through 4 in an amount of 0.01 mass % to 80 mass % on the basis of the entire mass of the composition.

16. The organic polymer composition according to claim 15, wherein the organic polymer of the composition is at least one species selected from the group consisting of a synthetic thermoplastic resin, a synthetic thermosetting resin, and a natural resin.

17. The organic polymer composition according to claim 15 or 16, which is a compound.

18. The organic polymer composition according to claim 15 or 16 above, which is a masterbatch.

19. A shaped product characterized by being produced through shaping of the organic polymer composition as recited in claim 15 or 16.

20. A slurry characterized by comprising the titanium dioxide as recited in any one of claims 1 through 4.

21. A coating agent characterized by comprising the titanium dioxide as recited in any one of claims 1 through 4.

22. A paint composition characterized by comprising the titanium dioxide as recited in any one of claims 1 through 4.

23. A structure characterized by comprising, on its surface, the titanium dioxide as recited in any one of claims 1 through 4.

24. A titanium dioxide single crystal characterized by being produced from the titanium dioxide as recited in any one of claims 1 through 4.

25. A ceramic shaped body characterized by being produced from the titanium dioxide as recited in any one of claims 1 through 4.

26. A dielectric raw material characterized by comprising the titanium dioxide as recited in any one of claims 1 through 4.

27. A cosmetic composition comprising the titanium dioxide as recited in any one of claims 1 through 4.
